(19) United States
(12) Patent Application Publication
(10) Pub. No.: US 2020/0091724 A1
(43) Pub. Date: Mar. 19, 2020

(54) MODULAR CONNECTIVITY AND ENERGY SYSTEMS WITH INTEGRATED CIRCUIT BOARDS AND ASSOCIATED DEVICES AND METHODS

(71) Applicant: Kumbaya, Inc., Rancho Palos Verdes, CA (US)

(72) Inventors: Michel Jacques Freni, Rancho Palos Verdes, CA (US); Anubhav Jagtap, Long Beach, CA (US); Hatem Saidane, Alisa Viejo, CA (US); Poonam B. Sara, Torrance, CA (US); Christian Jensen, Gardena, CA (US)

(21) Appl. No.: 16/573,318

(22) Filed: Sep. 17, 2019

Related U.S. Application Data
(60) Provisional application No. 62/732,411, filed on Sep. 17, 2018.

(51) Int. Cl. H02J 3/38; H02J 3/32; H02J 9/04; G05F 1/67; G06F 1/3218; G06F 1/26; H02J 7/00; H02S 10/40

(52) U.S. Cl. CPC H02J 3/383; H02J 3/32; H02J 9/04; G05F 1/67; G06F 1/3218; H02J 2007/0062; H02J 7/007; H02S 10/40; H02J 7/0047; H02J 7/0052; H02J 7/0068; G06F 1/263

(57) ABSTRACT

Modular connectivity and power management systems and associated devices and methods are disclosed herein. A modular system configured in accordance with implementations of the present technology can include, for example, a housing, a display, and a single, active printed circuit board including a variety of connectivity and energy management devices electrically coupled thereto. In some implementations, the printed circuit board can include a microprocessor, a micro controller, a power management system, a plurality of communication devices, and a USB port. The modular system can include an internal battery, an external battery, and can be configured to directly connect to a solar panel and/or a DC power source. The modular system can be configured to charge the internal battery before charging the external battery and/or can be configured to use power stored on the external battery before using power stored on the internal battery.

### CROSS-REFERENCE TO RELATED APPLICATION(S)

This application claims benefit of prior to U.S. Provisional Patent Application No. 62/732,411, filed Sep. 17, 2018, and entitled “MODULAR CONNECTIVITY AND ENERGY SYSTEMS WITH INTEGRATED CIRCUIT BOARDS AND ASSOCIATED DEVICES AND METHODS”. The foregoing application is incorporated herein by reference in its entirety.

### TECHNICAL FIELD

The present disclosure relates generally to systems for providing connectivity and delivering energy. More specifically, the present disclosure relates to modular connectivity and energy systems with integrated circuit boards and associated devices and methods.

### BACKGROUND

Many remote and/or underdeveloped regions of the world have limited access to electricity and connectivity. Other regions of the world have limited access to power and connectivity due to natural disasters, war, and other events that result in lack of infrastructure. Whether due to an occurrence or the location itself, these regions are unable to use certain hardware technologies (e.g., lighting at night) and/or connect with resources available on the Internet and/or on other information platforms. Thus, the standard of living, education, and healthcare in these regions often lag behind standard of living, education, and healthcare in more developed regions that provide the infrastructure necessary to consistently provide power and connectivity.

When electricity is made available in these remote, underdeveloped, and/or otherwise affected regions, such as through solar panels, the electricity is often insufficient to power each device in the home or to do so consistently. As such, an individual is forced to prioritize which devices receive power and attempt to optimize power consumption. Furthermore, when a device malfunctions or stops working, fixing the device often requires a specialized service technician, which may not be feasible or too costly in these remote, underdeveloped, and/or affected regions.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure. The drawings should not be taken to limit the disclosure to the specific implementations depicted, but are for explanation and understanding only.

FIGS. 1A and 1B are front and back isometric views, respectively, of a modular connectivity and power management system configured in accordance with implementations of the present technology.

FIG. 1C is an exploded isometric view of the modular connectivity and power management system shown in FIGS. 1A and 1B and configured in accordance with implementations of the present technology.

FIG. 2 is a schematic diagram of electrical devices, circuits, and/or components of a modular connectivity and power management system configured in accordance with implementations of the present technology.

FIGS. 3A and 3B are a front view and a back view, respectively, of a circuit board configured in accordance with implementations of the present technology.

FIG. 4 is a schematic diagram of a lighting control graphical user interface configured in accordance with implementations of the present technology.

FIGS. 5A and 5B are schematic diagrams of health management graphical user interfaces configured in accordance with implementations of the present technology.

FIG. 6 is a schematic diagram of a power management graphical user interface configured in accordance with implementations of the present technology.

FIG. 7 is a flow diagram illustrating a power management routine for charging batteries via a modular connectivity and power management system in accordance with implementations of the present technology.

FIG. 8 is a flow diagram illustrating a power management routine for managing battery power of a modular connectivity and energy management system in accordance with implementations of the present technology.

FIG. 9 is a block diagram of an environment in which a modular connectivity and power management system operates, configured in accordance with implementations of the present technology.

### DETAILED DESCRIPTION

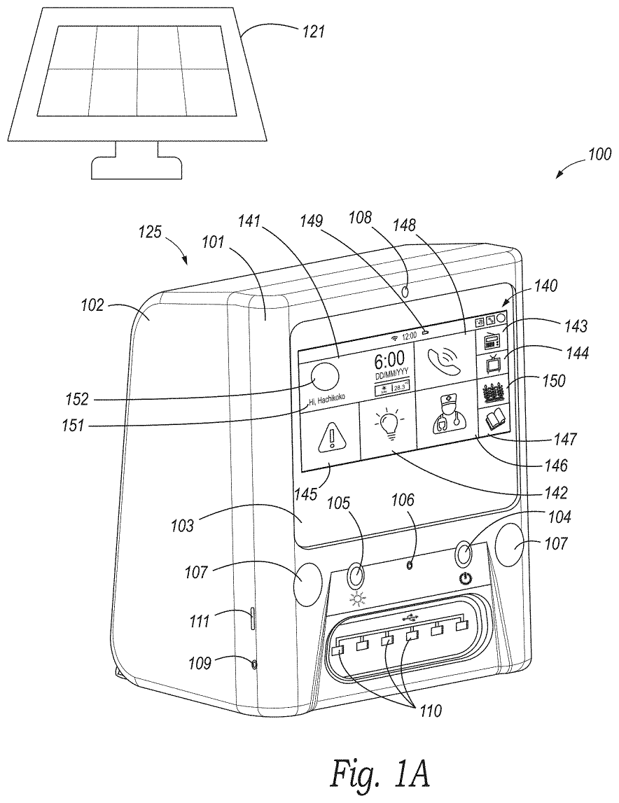

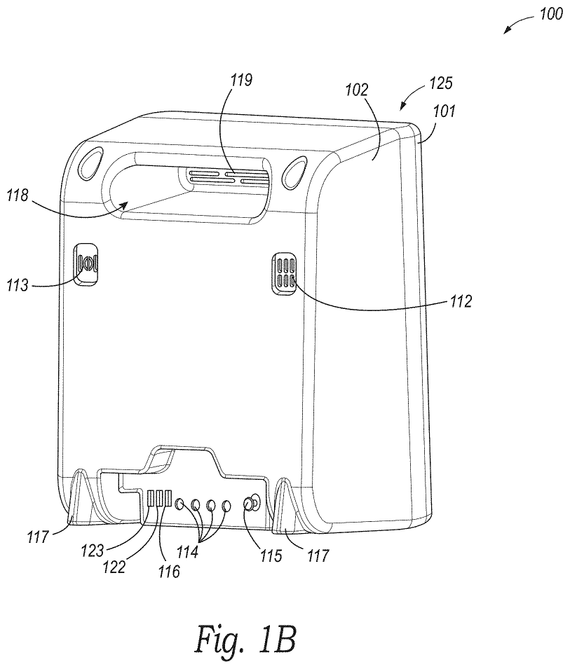

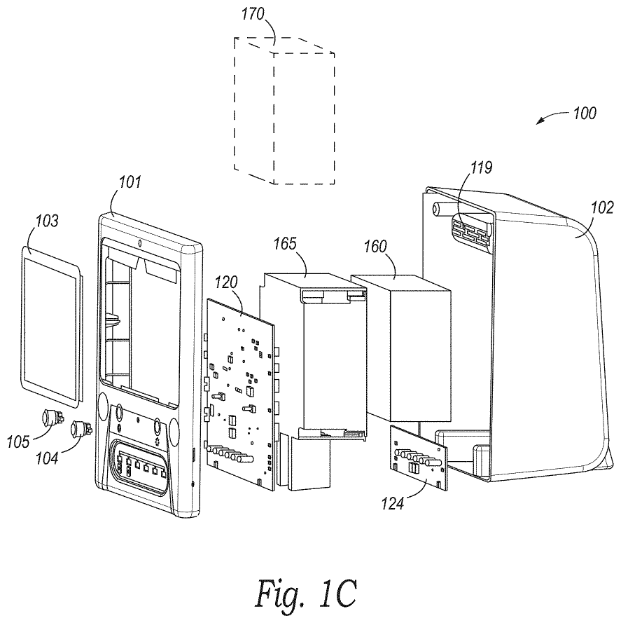

The following disclosure describes modular connectivity and power management systems with integrated circuit boards and associated devices and methods. As an example, the present disclosure describes modular systems having a single (e.g., only one), active printed circuit board (“PCB”) and associated methods for managing charging of and/or power storage in one or more batteries of the modular systems. Certain details are set forth in the following description and in FIGS. 1A-9 to provide a thorough understanding of various implementations of the disclosure. However, other details describing well-known structures and systems often associated with modular systems and associated methods are not set forth below to avoid unnecessarily obscuring the description of various implementations of the disclosure.

Many of the details, dimensions, angle, and other features shown in FIGS. 1A-9 are merely illustrative of particular implementations of the disclosure. Accordingly, other implementations can have other details, dimensions, angles, and features without departing from the spirit or scope of the present disclosure. In addition, those of ordinary skill in the art will appreciate that further implementations of the disclosure can be practiced without several of the details described below.

Some implementations of the present technology include a modular connectively and power management platform system having a housing, a display, and a single, active PCB. The active PCB includes a microprocessor, a micro controller, a power management system, a plurality of communication devices, and at least one output port (e.g., a USB port). The modular system can include a first or internal battery and a second or external battery. A solar panel and/or a DC power source can directly connect to the modular system to power devices, circuits, and/or components of the modular system and/or to charge the first battery and/or the second battery. In some implementations of the present technology, the modular system can serve as a communications and energy hub for individuals in rural, off-grid, and/or underdeveloped areas, as well as a communications and energy platform that can be deployed in emergency relief centers where there is no power and/or network connections are down in the region due to natural disasters or otherwise impaired infrastructure.

In some implementations of the present technology, the power management system, the microprocessor, and/or the micro controller can monitor power stored on the first battery and/or on the second battery. In these and other implementations, the modular system can be configured to preferentially charge the first battery before charging the second battery. In these and still other implementations the modular system can be configured to use power stored on the second battery before using power stored on the first battery. This and other features can be used to prolong the operation time of the entire system when there is limited or no electricity.

### A. SELECTED IMPLEMENTATIONS OF MODULAR CONNECTIVITY AND POWER MANAGEMENT SYSTEMS AND ASSOCIATED METHODS

FIGS. 1A and 1B are front and back isometric views, respectively, of a modular connectivity and power management system 100 (“the modular system 100” or “the system 100”) configured in accordance with implementations of the present technology. Referring to FIG. 1A, the modular system 100 includes a housing 125 having a front cover 101, a back cover 102, and a display or screen 103 accessible via an opening in the front cover 102. In some implementations, the front cover 101 and/or the back cover 102 can be made from one or more polymers (e.g., one or more plastics or resins) such that the front cover 101 and/or the back cover 102 are chemical resistant and/or provide the system 100 high-impact durability. The screen 103 can be an LCD display or monitor and/or can be configured as a (e.g., capacitive) touchscreen. In other implementations, the screen 103 can be another type of display, such as an LED or plasma display, and/or the screen 103 can be configured as a non-touch display. In the illustrated implementation, the front cover 101, the back cover 102, and the screen 103 are configured to interface (e.g., connect) with one another such that the system 100 is sealed and/or water resistant (e.g. protected against vertical water drop) at least at locations where the front cover 101, the back cover 102, and/or the screen 103 interface with one another.

The system 100 can include a system power button 104 (e.g., a system on/off switch) and/or an external device power button 105. In operation, the system power button 104 can be configured to toggle power to the system 100, and the external device power button 105 can be configured to toggle power to one or more external devices, such as lamps or other lighting devices, that are electrically connected to the system 100. In some implementations, for example, when a user actuates the external device power button 105, the system 100 can be configured to turn on one or more external lamps that are connected to the system 100 in accordance with a programmable default. For example, the system 100 can turn on all external lamps connected to the system 100 when the user actuates the external device power button 105. In these and other implementations, the system 100 can include an LED indicator light (not shown). The indicator light can indicate to a user a status of the system 100. For example, the indicator light can use various different colors, projection patterns, and/or other light-related indicators when the system 100 is powered on, powered off, and/or in sleep mode; when the system 100 is fully charged, when the system 100 is connected to a power source (e.g., charging); when the system 100 is not connected to a power source; when the system 100 is running low on power; and/or when the system 100 is fully drained of power. In these and still other implementations, the indicator light can be configured to indicate other statuses of the system 100, such as when a system error occurs and/or when a device in the system 100 is malfunctioning or not working.

As described in greater detail below, the system 100 can include various (i) input and/or output devices and/or (ii) input and/or output ports to allow a variety of external devices to connect to the system 100. As shown in FIG. 1A, for example, the system 100 can include a microphone 106, one or more speakers 107, a camera 108, an audio (e.g. head phone) jack and/or an external microphone jack 109, one or more (e.g., six) USB ports 110, and/or an SD card reader 111. In some implementations, the speakers 107 includes 8 Ohm loud speakers. In these and other implementations, the speakers 107 can be electrically coupled to an amplifier (not shown), such as a 3 W/channel filter-less class D amplifier, to drive the speakers 107, to protect the speakers 107 from overheating, and/or to limit audio output levels of the speakers 107. In these and still other implementations, the camera 108 can be a single chip, mobile industry processor interface camera, such as a 5-megapixel camera with high volume autofocus. In these and other implementations, the USB ports 110 can be USB 2.0 ports, USB 3.0 ports, and/or USB charging ports configured to connect the system 100 to one or more external devices (e.g., laptops, computers, tablets, mobile phones, refrigerators, sewing machines, medical devices, etc.).

As shown in FIG. 1B, the system 100 can include other devices integrated into the system 100 and/or ports for connection to external devices. For example, the system 100 can include a temperature sensor 112, a carbon monoxide (CO) sensor 113, one or more (e.g., four) external lamp ports 114, a TV antenna or cable jack 115, and/or a DC power supply port 116. The external lamp ports 114 can be configured to electrically couple one or more external lamps, such as one or more LED lights, to the system 100 via a wire or cable (not shown). Similarly, the DC power supply port 116 can be configured to connect the system 100 to a DC power source via a wire or cable (not shown). In these and other implementations, the system 100 can include other electrical connection ports in addition to or in lieu of the DC power supply port 116. For example, the system 100 can include a solar panel port 122 configured to connect the system 100 to one or more solar panels 121, such as one or more ST36P small panel series solar panels. In these and other implementations, the system 100 can include a power source port 123 configured to connect the system 100 to an electrical outlet and/or another power source, such as an external or second battery 170.

While the modular system 100 is shown in FIGS. 1A and 1B as including specific input and/or output devices and/or specific input and/or output ports, modular connectivity and power management systems configured in accordance with other implementations of the present technology can include other input and/or output devices and/or input and/or output ports. For example, modular systems configured in accordance with other implementations of the present technology can include a radio dial, a radio antenna, a television tuner dial, and/or an LTE antenna. In these and other implementations, modular systems can include a micro SIM card reader, a micro SD card reader, and/or one or more other electrical outlets.

Referring again to FIG. 1B, the back cover 102 of the modular system 100 can include one or more functional features. For example, the back cover 102 can include one or more fins 117. The fins 117 can provide stability to the base of the modular system 100. In these and other implementations, the back cover 102 can include a recess 118. The recess 118 can enable a user to grip the system 100 to lift and/or move the system 100. In these and still other implementations, the back cover 102 can include one or more vents 119 to permit exhaust of hot air and/or cooling of electrical components within the system 100 when the electrical components heat up during use of the system 100. In the illustrated implementations, the back cover 102 includes a vent 119 within the recess 118 to limit exposure of the electrical components to water or other liquids, particles, and/or substances.

FIG. 1C is an exploded isometric view of the modular system 100 shown in FIGS. 1A and 1B and configured in accordance with implementations of the present technology. As shown, the system 100 includes the screen 103, the system power button 104, and the external device power button 105 that are each configured to interface with the front cover 101. The system 100 can include a single (e.g., only one), active printed circuit board 120 (“the PCB 120”) that electrically couples each of the electrical ports, devices, circuits, and/or components of the system 100 together. In these and other implementations, the system 100 can include a trace extender or passive board 124 (“the passive board 124”) in addition to the active PCB 120. The passive board 124 can be a printed circuit board, but differs from the active PCB 120 in that it includes only ports (e.g., the external lamp ports 114, the DC power supply port 116, the solar panel port 122, and/or the power source port 123), traces, and/or other circuit components configured to: (i) receive power into the system 100, and/or (ii) distribute power to various active components on the active PCB 120 and/or to external components (e.g., lamps) connected to the system 100. As such, the passive board 124 extends the traces of the active PCB 120 such that the system 100 can connect to external lamps and/or power sources at a desired location, such as at the back cover 102 of the system 100. In contrast, as described in greater detail below, the active PCB 120 includes various active components and circuits that control and manipulate electricity and/or other signals to perform one or more functions of the system 100.

As further shown in FIG. 1C, the system 100 can include a battery cover 165 that houses an internal or first battery 160 within the system 100 when the front cover 101 and the back cover 102 interface with one another. In some implementations, the first battery 160 is a lithium ion battery. For example, the first battery 160 can be a 12V LiFePO₄ battery. In other implementations, the internal battery can be a sealed lead-acid (SLA) battery, a wet cell (e.g., flooded) battery, a gel (e.g., gel cell) battery, an absorbed glass mat (AGM) battery, and/or another type of battery. The system 100 can also include an external or second battery 170 positioned external to the main cavity of the housing 125 (FIG. 1A). In some implementations, the second battery 170 is identical to the internal battery 160 and/or is configured to plug into one of the system's ports (e.g., into the DC power supply port 116, the solar panel port 122, and/or into the power source port 123) to supply power to the system 100.

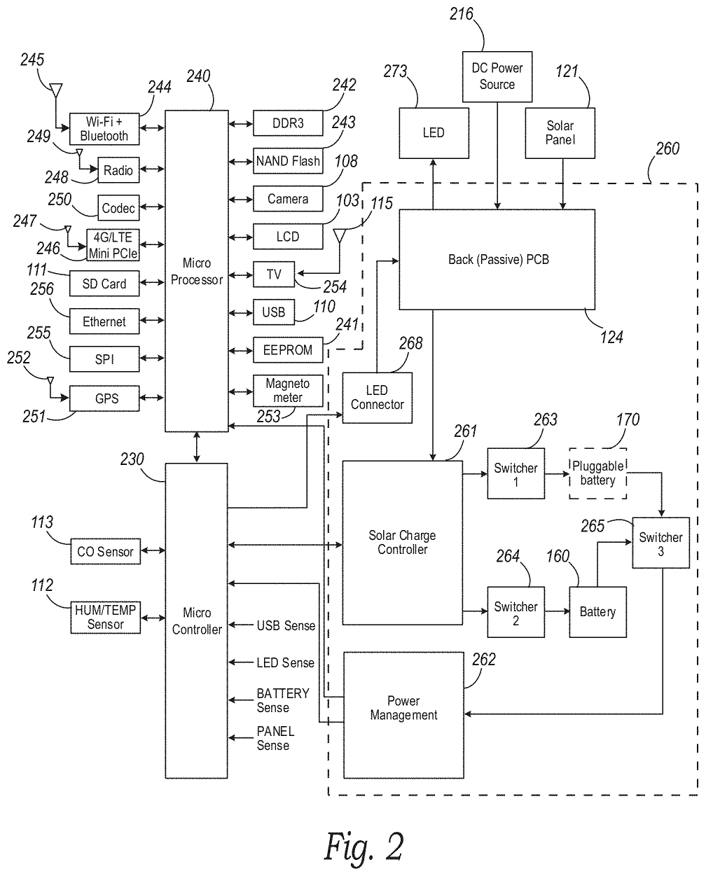

FIG. 2 is a schematic diagram of electrical devices, circuits, and/or components of the system 100 shown in FIGS. 1A-1C and configured in accordance with implementations of the present technology. As shown, the system 100 includes three primary components: a micro controller 230, a microprocessor 240, and a power management system 260. In some implementations, the microprocessor 240 is a part of the micro controller 230. The micro controller 230 is a single chip micro controller. In other implementations, the micro controller 230 can be special purpose logic circuitry (e.g., a field programmable gate array (FPGA), an application specific integrated circuit (ASIC), etc.) or another suitable processor. The micro controller 230 can include (i) a processor (not shown), such as a microprocessor or an on-chip processor, and/or (ii) an embedded memory (not shown). The processor of the micro controller 230 can be configured to execute instructions stored in the embedded memory. For example, the embedded memory can be configured to store various processes, logic flows, and routines for controlling operation of the modular system 100, including managing communications between the various electrical circuits, devices, and/or components included on and/or connected to the system 100. In some implementations, the embedded memory can include memory registers storing, for example, memory pointers, fetched data, etc. The embedded memory can include read-only memory (ROM) for storing microcode. In these and other implementations, the micro controller 230 can be configured to utilize Advanced RISC Machine (ARM) based architecture for program memory,

As shown in FIG. 2, the micro controller 230 can sense when various external components are connected to the system 100 and perform various functions associated with the connected external components. For example, the micro controller 230 can sense when an external lamp 273 is connected to an external lamp port 114 (FIG. 1B) via the passive board 124 and an LED connector 268 of the active PCB 120, sense when a DC power source 116, a second battery 170, and/or one or more solar panels 121 are connected to the system 100 via the back board 124, and/or sense when one or more other devices are connected to one or more of the USB ports 110 (FIG. 1A) of the active PCB 120. The micro controller 230 can also load appropriate drivers for the one or more connected devices. In these and other implementations, the micro controller 230 can monitor power consumption of each external lamp 273, electrical circuit, device, and/or component on and/or connected to the system 100. For example, the micro controller 230 can manage power supplied to and/or consumed by each of the electrical circuits, devices, and/or components on and/or connected to the system 100.

The temperature sensor 112, the CO sensor 113, and/or other detection devices can directly interface with the micro controller 230. In some implementations, the temperature sensor 112 can be configured to measure both moisture (e.g., relative humidity in the air) and air temperature and/or output a calibrated digital signal based on the detected temperature and/or humidity information to the micro controller 230. In these and other implementations, the CO sensor 113 can be configured to sense CO concentrations (e.g., between 20 and 2000 ppm) in an atmosphere surrounding the system 100. In these and still other implementations, the CO sensor 113 can sense CO concentrations in real time and/or can output a digital signal to the micro controller 230 indicative of the measured CO concentrations. If a CO concentration measurement indicates a CO concentration above a threshold value, the micro controller 230 can trigger a visual warning on the screen 103 (FIGS. 1A and 1C) of the system 100 and/or an audio alarm (e.g., using the speakers 107 of the system 100 shown in FIG. 1A).

The micro controller 130 can also directly interface with the microprocessor 240 and/or the power management system 260. As described in greater detail below, the micro controller 230 can monitor and/or manage power levels indicated by the power management system 260. For example, the micro controller 230 can monitor: (i) power levels of the first battery 160 and/or of the second battery 170; and/or (ii) power consumption of various electrical circuits, devices, and/or components within and/or operably connected to the system 100. In response, the micro controller 230 can command various devices, circuits, and/or components of the system 100 to perform one or more power management functions (e.g., to charge a particular battery; to use power stored on a particular battery; to supply power to a particular circuit, device, and/or components within and/or connected to the system 100; to limit power supplied to a particular circuit, device, and/or component within and/or connected to the system 100; etc.). In these and other implementations, the micro controller 230 can: (i) track power consumption over time; and/or (ii) notify a user when an electrical circuit, device, and/or other component is consuming a large amount of power and/or when current consumption of power is exceeding the charging capacity and/or charging rate of the system 100.

The microprocessor 240 is configured to communicate with one or more peripheral devices, circuits, and/or components of the system 100. For example, the microprocessor 240 can be configured to execute instructions stored in memory, including various processes, logic flows, and routines for controlling operation of the system 100 and/or for managing communications between the various electrical circuits and devices on and/or connected to the PCB 120. In some implementations, the microprocessor 240 can be configured to communicate with peripheral circuits and/or devices in accordance with these instructions (e.g., in accordance with I2C protocol). As shown in FIG. 2, memory used to store the instructions can include electrically erasable programmable read-only memory 241 (“the EEPROM 241”), double data rate 3 dynamic random-access memory 242 (“the DDR3 DRAM 242”), and NAND flash memory 243 (“the NAND flash 243”). The EEPROM 241, for example, can be configured to store boot instructions of the system 100. The DDR3 DRAM 242 can permit high speed data transfers while the system 100 remains powered on and/or while power is supplied to the system 100. The NAND flash 243 can provide non-volatile memory storage (e.g., to store user information).

Peripheral devices, circuits, and/or components in communication with the microprocessor 240 can include various communication devices, circuits, and/or components on and/or connected to the system 100. For example, the system 100 can include WiFi and/or Bluetooth controller(s) 244. A WiFi controller (e.g., an IEEE 802.11 b/g/n/RF/Baseband/Medium Access Control (MAC) link controller) can allow the system 100 to wirelessly connect to the internet. In some implementations, the WiFi controller can wirelessly connect to the internet by leveraging TV white space channels. A Bluetooth controller (e.g., a Bluetooth 4.0 compliant module or controller) can allow the system 100 to communicate with Bluetooth compatible devices. In some implementations, the Bluetooth module can be optimized for low power consumption. In some implementations, the system 100 can include an WiFi and/or Bluetooth antenna 245 to improve signal strength.

In these and other implementations, the system 100 includes an integrated mobile communication device 246 and associated cellular communication circuits. For example, the system 100 can include a 4G/LTE Mini PCIe module having a RF transceiver, cellular baseband processor, and power supply circuit. The integrated mobile communication device 246 and/or the associated cellular communication circuits can be universal asynchronous receiver-transmitter (DART) interfaced to the microprocessor 240. In these and other implementations, the PCB 120 can include a SIM card tray to receive a SIM card carrying an identification number unique to the owner of the system 100. In these and still other implementations, the system 100 can include a mobile communication or cellular antenna 247 linearly polarized with typical operating frequencies. The mobile communication device 246, the cellular communication circuits, and the cellular antenna 247 can enable the system 100 to place and receive wireless communication (e.g., voice calls) with 2G/3G/3.75G/4G/5G mobile device users.

The microprocessor 240 can be in communication with additional peripheral circuits, devices, and/or components, such as a radio 248. For example, the system 100 can include a RF CMOS radio to support FM frequency bands (e.g., 64-108 MHz), AM frequency bands (e.g., 520-1710 kHz), weather (WB) frequency bands (e.g., 162.4-162.55 MHz), shortwave radio frequency bands (e.g., 2.3-30 MHz), and/or long wave radio frequency bands (e.g., 153-288 kHz). In some implementations, the radio 248 can interface with the microprocessor 240 using a UART/CTRL interface configuration. The radio 248 can include a RF unit, one or more RF amplifiers, a frequency modulated detector, and an audio frequency amplifier. In some implementations, the system 100 includes a radio antenna 249 for better reception of RF signals. In these and still other implementations, the system 100 can include internet and/or terrestrial (e.g., satellite) radio.

In some implementations, the microprocessor 240, the integrated mobile communication device 246, the associated cellular communication circuits, and/or the radio 248 can interface with a codec 250. The codec 250 can be a lower power, high fidelity codec with integrated fixed audio digital signal processors targeted to various audio devices of the system 100, such as the microphone 106, the audio and/or external microphone jack 109 (FIG. 1A), and/or the speakers 107 (FIG. 1A). The codec 250 can disable speaker output and can enable headphone output when the codec 250 detects head phones are inserted in the audio and/or external microphone jack 109. In these and other implementations, the codec 250 can bias electric type microphones, and/or can sample analog inputs to produce digital audio outputs using an analog-to-digital converter.

The microprocessor 240 can also interface with a global positioning system (GPS) module 251 using, e.g., a UART interface configuration. The GPS module 251 can include a GPS receiver coupled to a GPS antenna 247 capable of receiving RF GPS signals from in view satellites. In operation, navigation information can be retrieved from a GPS server and/or a navigation server via wireless communication channels (e.g., after a location and destination are input into the system 100 via a navigation graphical user interface displayed on the screen 103). In these and other implementations, the system 100 can include security and/or theft software that can disable one or more applications and/or functions of the system 100 in the event the system 100 is compromised (e.g., hacked, lost, or stolen). In these implementations, the GPS module 251 can aid in recovering the system 100 by providing current position information of the system 100.

In these and further implementations, the microprocessor 240 interfaces with a magnetometer 253. The magnetometer 253 can be digitized and/or can be used in conjunction with a three-axis accelerometer (not shown) to produce an orientation independent electronic compass. The orientation independent electronic compass can provide accurate heading information.

In some implementations, the microprocessor 240 interfaces with a TV module 254. The TV module 254 can include one or more TV tuners and a TV demodulator to enable television viewing on the screen 103 and/or an external device operably connected to the system 100. The TV tuners can be single chip integrated circuit(s) and can be connected to a TV antenna or cable via the TV antenna or cable jack 115. The TV module 254 can support a USB 2.0 interface; can support 2K or 8K mode with 6, 7, and 8 MHz bandwidth; and/or can run using inputs such as a USB Dongle, cable TV, digital video broadcasting-terrestrial (DVBT), over the air (OTA) TV, and/or double-sideband TV, among other inputs.

In some implementations, the microprocessor 240 can interface with one or more other circuits, devices, and/or components. For example, the microprocessor 240 can interface with a Secure Digital (SD) card (not shown) inserted into the SD card reader 111 (FIG. 1A). In these and other implementations, the microprocessor 240 can interface with other serial peripheral interface (SPI) devices 255, such as a second SD card (e.g., a micro SD card) in a second SC card reader and/or one or more other sensors. In these and still other implementations, the microprocessor 240 can interface with one or more ethernet cables connected to one or more ethernet jacks 256 of the system 100. In these and still other implementations, the microprocessor 240 can interface with the screen 103, the camera 108, and/or the USB ports 110. For example, the USB ports 110 can include USB 2.0 ports, USB 3.0 ports, and/or USB fast charging ports. When one or more external devices (e.g., laptops, computers, tablets, mobile phones, refrigerators, sewing machines, medical devices, etc.) are connected to the system 100 via one or more of the USB ports 110 and/or other connection means, the microprocessor 240 can interface with the one or more connected devices. For example, the microprocessor may download data from a connected device, upload or store data to a connected device, charge a connected device, receive inputs from and/or send outputs to a connected device, and/or otherwise interface with the externally connected devices.

As further shown in FIG. 2, the power management system 260 interfaces with both the micro controller 230 and the microprocessor 240. In the illustrated implementation, the power management system 260 includes a solar charge controller 261, a power management module 262, switcher circuits 263-265, an LED connector 268, and ports (e.g., external lamp ports 114 (FIG. 1B), the DC power supply port 116 (FIG. 1B), solar panel ports 122 (FIG. 1B), and/or other power source ports 123 (FIG. 1B)) positioned at a specific portion, e.g., the passive board 124 and/or the active PCB 120 of the system 100. Additionally or alternatively, one or more external LED's 273, one or more solar panels 121, the DC power source 216, the first battery 160, and/or the second battery 170 can be considered a part of the solar management system 260 when connected to the system 100.

In operation, the power management system 260 operates as a buck-boost switching regulatory battery charger that implements constant-current constant-voltage (CCCV) charging for the first battery 160 and/or the second battery 170. Logic stored on the solar charge controller 261 can provide automatic maximum power point tracking (MPPT) for solar powered applications. In some implementations, the solar charge controller 261 can perform automatic temperature compensation by sensing one or more external thermistors that are thermally coupled to the first battery 160 and/or to the second battery 170. STATUS and/or FAULT pins on the solar charge controller 261 can be used to drive the various colors and/or patterns projected by the indicator light (not shown). As described in greater detail below, a shutdown SHDN pin of the solar charge controller 261 can be used as an enable pin to dictate when the first battery 160 is charged and/or is used vis-a-vis the second battery 170.

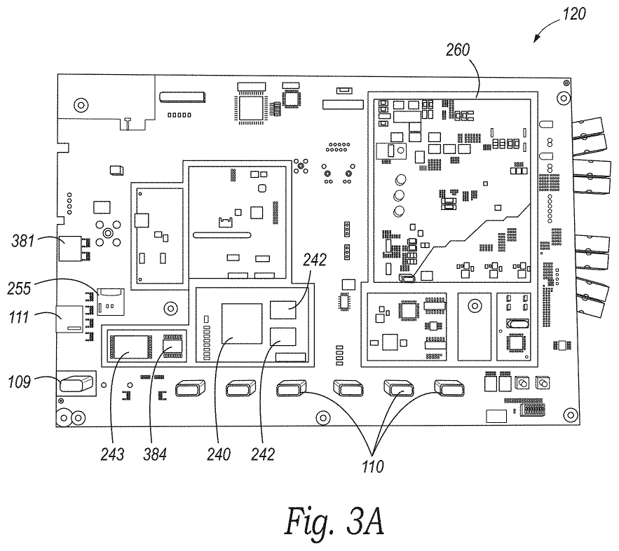

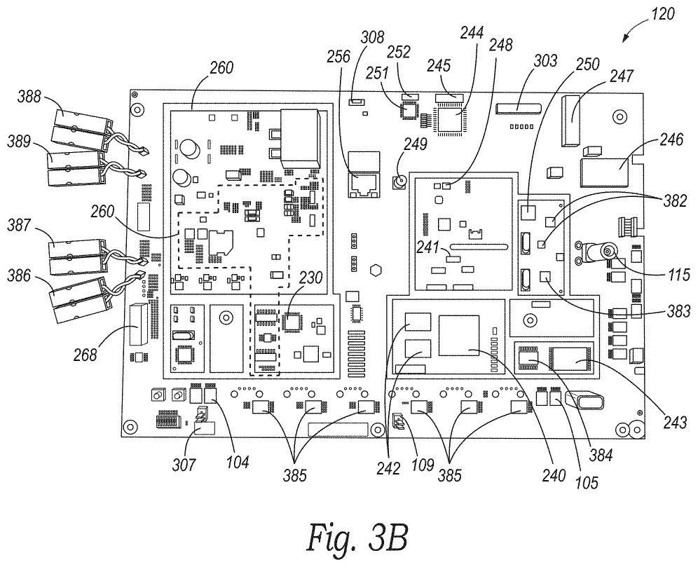

FIGS. 3A and 3B are a front view and a back view, respectively, of the PCB 120 configured in accordance with implementations of the present technology. As discussed above, the modular system 100 can include a single (e.g., only one), active PCB 120. This enables a user to remove and, optionally replace the entire PCB 120 whenever a device, circuit, and/or component of the PCB 120 malfunctions and/or otherwise stops working. Rather than typical computer systems with numerous active PCBs arranged intricately within the external housing, the single, active PCB 120 allows for quick and simple repair the modular system 100 because only the single, active PCB 120 needs to be fixed or replaced. For example, referring to FIG. 3B, the PCB 120 can include an external battery plug 386, an internal battery plug 387, a solar power plug 388, and a DC power plug 389 arranged on the same exterior portion of the PCB 120. The plugs 386-389 can facilitate easy installation and/or swapping of a malfunctioning and/or inoperable PCB 120 with a properly functioning PCB 120. As explained above, the system 100 can additionally include the passive board 124 (FIG. 1C) in addition to the active PCB 120 to provide stability to the plugs 386-389 and/or to facilitate connection with solar panels 121 (FIG. 1A), external lamps 273 (FIG. 2), DC power sources 216 (FIG. 2), external batteries 170 (FIGS. 1C and 2), and/or other devices and/or power sources at the back cover 102 of the system 100.

As discussed above with respect to FIG. 2, the system 100 includes numerous devices, circuits, and/or components on and/or electrically connected to the PCB 120. Many of these devices, circuits, and/or components transmit signals that propagate through traces of the PCB 120. Due to the large quantity of traces within the single PCB 120, the PCB 120 can include features that enhance the signal integrity within the traces. As such, the devices, circuits, and/or components can be positioned on the PCB 120 in such an orientation that signal integrity for each device, circuit, and/or component is maintained. For example, the components on the PCB 120 can be arranged in a specific manner to reduce, minimize, and/or at least substantially eliminate crosstalk between propagating signals on the PCB 120.

In some implementations, the positions of one or more devices, circuits, and/or components are selected based on considerations of the most feasible and/or most suitable locations for external access from the system housing (e.g., covers 101, 102 (FIGS. 1A-1C) and/or for interaction with hardware features of the system 100. For example, the externally accessible devices can be positioned generally around a peripheral or edge portion of the PCB 120 at positions at least generally corresponding the positions at which they are accessible to the user via openings within the system housing. As shown in FIG. 3A, the USB ports 110 are positioned on the front of the PCB 120 such that the USB ports 110 can be presented to and/or accessed by a user at a desired position on the front of the system 100 (e.g., through the front cover 101 shown in FIG. 1A). Similarly, the electrostatic discharge diodes 385 (FIG. 3B) are selectively positioned at a front portion on the back side of the PCB 120 in communication with the USB ports 110 (FIG. 3A). As further shown in FIG. 3A, the audio and/or external microphone jack 109 and/or the SD card reader 111 are selectively positioned along a side portion of the PCB 120 such that a user can insert headphones, an external microphone, and/or a SD card into the side portion of the system housing. As shown in FIG. 3B, an LCD connector 303, one or more speaker connectors 307, a camera connector 308, and/or an LED connector 268 can be positioned generally around the edge portion of the PCB 120 to facilitate connecting the LCD 103 (FIG. 1A), the speakers 107 (FIG. 1A), the camera 108 (FIG. 1A), and the LED 273 (FIG. 2), respectively, to the active PCB 120 while also minimizing vibrations experienced by the connectors while a user connects and/or interacts with various (e.g., external and/or externally accessible) devices and/or components of the system 100. In other implementations, the devices that interface with externally accessible components of the system 100 can be arranged at other locations on the PCB 120 to correspond with the associated ports within the system housing.

In these and other implementations, the remaining internal devices, circuits, and/or components of the system 100 (e.g., the devices, circuits, and/or components on the PCB 120 that do not have positions on the PCB 120 that are selected by user interaction considerations) are selectively positioned to maintain the signal integrity for each device, circuit, and/or component. For example, the power management system 260 includes several devices, circuits, and/or components that frequently handle high power and/or high current signals. As such, as shown in FIGS. 3A and 3B, the devices, circuits, and/or components of the power management system 260 are positioned together on the PCB 120 and are spaced (e.g., at least 2 cm) apart from the adjacent other devices, circuits, and/or components on the PCB 120. This helps to maintain signal integrity by minimizing and/or eliminating crosstalk between the high power and/or high current signals of the power management system 260 and signals transmitted and/or manipulated by the other devices, circuits, and/or components on the PCB 120.

In these and still other implementations, the system 100 can be configured such that only one or two communication modules (e.g., WiFi, Bluetooth, Cellular, GPS, etc.) manipulate and/or transfer data signals at the same time. As such, communication data signals have limited, if any, crosstalk across communication modules. For this reason, the communication modules can be grouped together on the PCB 120. As shown in FIG. 3B, for example, the GPS module 251, the GPS antenna 252, the WiFi and/or Bluetooth controller(s) 244, the WiFi and/or Bluetooth antenna 245, the mobile communication device 246, and the cellular antenna 247 are grouped together on a back portion the PCB 120. Nevertheless, the communication modules can be spaced apart as much as possible from one another to reduce crosstalk between the modules while also remaining spaced (e.g., at least 2 cm) apart from the power management system 260.

Similarly, the system 100 can be configured such that the radio 248 and/or the TV 254 (FIG. 2) typically do not manipulate and/or transfer data signals at the same time as one another and/or at the same time as the communication modules. Thus, data signals transmitted and/or manipulated by the radio 248, the TV 254, and/or the communications modules will have little to no interference with each other. For this reason, as shown in FIG. 3B, components of the radio 248 and the TV 254 can be positioned proximal one another and proximal to the communication modules on the PCB 120. For example, the radio antenna 249, the radio 248, the TV tuner(s) 382, the TV antenna 115, and the TV demodulator 383 are positioned near one another on the back portion of the PCB 120. Nevertheless, the device, circuits, and/or components of the radio 248, the TV 254, and the communication modules can be spaced apart as much as possible from one another to reduce crosstalk between these devices, circuits, and/or components, while also remaining spaced (e.g., at least 2 cm) apart from the power management system 260.

To further reduce crosstalk across devices, circuits, and/or components on the PCB 120, the PCB 120 can be layered and/or can include grounded data lines (e.g., DC shield lines) between transmission lines of different devices, circuits, and/or components. The layers and/or the grounded data lines can prevent one data line from acting as an aggressor to another victim data line as the data lines are switched on the PCB 120. The layers and/or grounded data lines can also reduce noise on the transmission lines, which can maintain and/or improve signal-to-noise ratios of data signals transmitted on the PCB 120. In some implementations, the grounded data lines do not run proximal one or more antennas of the system 100. For example, the cellular antenna 247 shown in FIG. 3B is positioned away from (i) grounded data lines and/or (ii) other devices, circuits, and/or components that include copper or other materials (e.g., conductors) that can interfere with signal transmission and/or reception of the cellular antenna 247.

In these and other implementations, one or more devices, circuits, and/or components of the system 100 can be positioned on the PCB 120 to minimize latency and/or to maximize speed of data transfers between one or more devices, circuits, and/or components of the PCB 120. For example, memory devices, circuits, and/or components of the system 100 (e.g., the DDR3 DRAM 242, the NAND flash 243, the EEPROM 241, the SD card reader 111, the SPI device reader 255, and/or NOR flash memory 384) can be placed in close proximity (i.e., as near as possible) to the microprocessor 240 on the PCB 120. In these and other implementations, the devices, circuits, and/or components (i) of the radio 248 and/or (ii) of and/or associated with the mobile communication device 246 can be positioned in close proximity to the codec 250. Similarly, a SIM card reader 381 can be positioned in close proximity to the mobile communication device 246. In these and still other implementations antennas of the system (e.g., the TV antenna 115, the cellular antenna 247, the WiFi and/or Bluetooth antenna 245, the radio antenna 249, and/or the GPS antenna 252) can be positioned as close as possible to their respective devices, circuits, and/or components on the PCB 120.

Referring again to FIG. 1A, the modular system 100, in operation, is configured to provide a variety of services to a user and/or to facilitate use of one or more functions. In some implementations, the user can view, access, and/or interface with several of these services and/or functions via a graphical user interface (GUI) 140 that can be presented on the screen 103 when the system 100 is powered on. As shown in FIG. 1, the GUI 140 can include one or more apps, buttons, or tiles corresponding to several of the services and/or functions. For example, the GUI 140 can include a general information tile 141, a lighting tile 142, a radio tile 143, a television tile 144, an alerts and/or errors tile 145, a health tile 146, an education tile 147, a video/voice call tile 148, a power management button 149, and/or a smart farming tile 150. In these and other implementations, the GUI 140 can include other apps, buttons, and/or tiles in addition to or in lieu of one or more of the tiles illustrated in FIG. 1A. For example, the GUI 140 can include a voice call tile, a navigation tile, an internet tile, a camera tile, a text and/or email tile, and/or tiles corresponding to one or more devices connected to the system 100.

The apps, button, and/or tiles of the GUI 140 can display a variety of information. For example, the general information tile 141 can present general information on the home GUI 140 so that the general information is readily available to the user. The general information can include the current date, current time, current weather and/or projected weather forecast, current temperature, and/or current humidity at or near the system's 100 current location. In these and other implementations, the general information tile 141 can display additional or other information, such as time and/or weather information of different locations, a profile 151 (e.g., a user or owner of the system 100), and/or a profile identifier 152 (e.g., a picture or icon). Other tiles can simply illustrate icons or titles that indicate the function to which they pertain. For example, the video/voice call tile 148 can display an online voice/video messaging icon (e.g., a skype icon) or phone symbol indicating that the video/voice call tile 148 corresponds to video and/or voice calls.

A user can select a particular tile on the GUI 140 by touching the tile on the touch screen 103, clicking onto the tile via a mouse, navigating to the tile via a keyboard and/or other buttons, and/or otherwise toggle and select the tiles of the GUI 140. Once the user selects a tile, a separate GUI corresponding to the selected tile (e.g., specific to the selected service and/or function) can be displayed on the screen 103. For example, when the user selects the general information tile 141, the system 100 can display a general information GUI (not shown) on the screen 103 to present more detailed information than shown on the initial GUI 140, such as graphs other visualizations of the recent or future temperature, humidity, and/or of CO levels; weather projections at the current location for the next week or another period of time; weather and/or time information of other locations; and/or profile information. In these and other implementations, when the user selects the radio tile 143 or the television tile 144, the system 100 can display a radio GUI or a television GUI, respectively, on the screen 103 to allow the user to select a radio or TV channel (e.g., via presets and/or a digital dial). The television GUI can additionally or alternatively present a television picture on the screen 103 within the television GUI.

When the user selects the alerts and/or errors tile 145, the system 100 can display an alerts and/or errors GUI on the screen 103 to present urgent information related to the overall functionally of the system 100 and/or items associated with the user's location. Information presented on the alerts and/or errors GUI can include the following: alarms, including when CO concentration levels are above a threshold level, when a natural disaster or dangerous event is occurring and/or has occurred nearby; warnings, including when one or more devices, circuits, and/or components of the system 100 malfunctions, when the system 100 needs to be serviced, or when system security has been breached; and/or notifications, including when a software update is available. The alerts and/or errors GUI can also present help information and/or contact information, such as the ability to contact local authorities, the fire department, service technicians, and/or previously stored emergency contacts. In these and other implementations, the alerts and/or errors tile 145 can be an emergency SOS tile. For example, when a user selects the alerts and/or errors tile 145, the system 100 can send a SMS alert to one or more of the user's (e.g., emergency) contacts indicating that the user needs emergency aid.

In these and other implementations, when a user selects the education tile 147, the system 100 can display an education GUI on the screen 103. The education GUI can allow the user to select an appropriate age or grade level and/or a topic of education. In response, the education GUI can display one or more lessons that the user can select to read, listen, and/or watch. In these and still other implementations, the education GUI can display or otherwise transmit live and/or recorded lessons and/or lectures (e.g., occurring elsewhere in the world). In some implementations, lessons can be stored on a remote server and/or database. In these implementations, the user can access the lessons via the education tile 147 and/or via a network (e.g., the internet and/or using the WiFi controller 244).

When the user selects the video/voice call tile 148, the system 100 can display a video/voice call GUI on the screen 103. In some implementations, the video/voice call GUI can be a Skype GUI. The video/voice call GUI can present the user a list of contacts with corresponding contact information, a key or number pad, and/or buttons to place and/or answer calls. The video/voice call GUI can be configured to display the user (e.g., within the field of view of the camera 108) and/or other individuals who are part of the call.

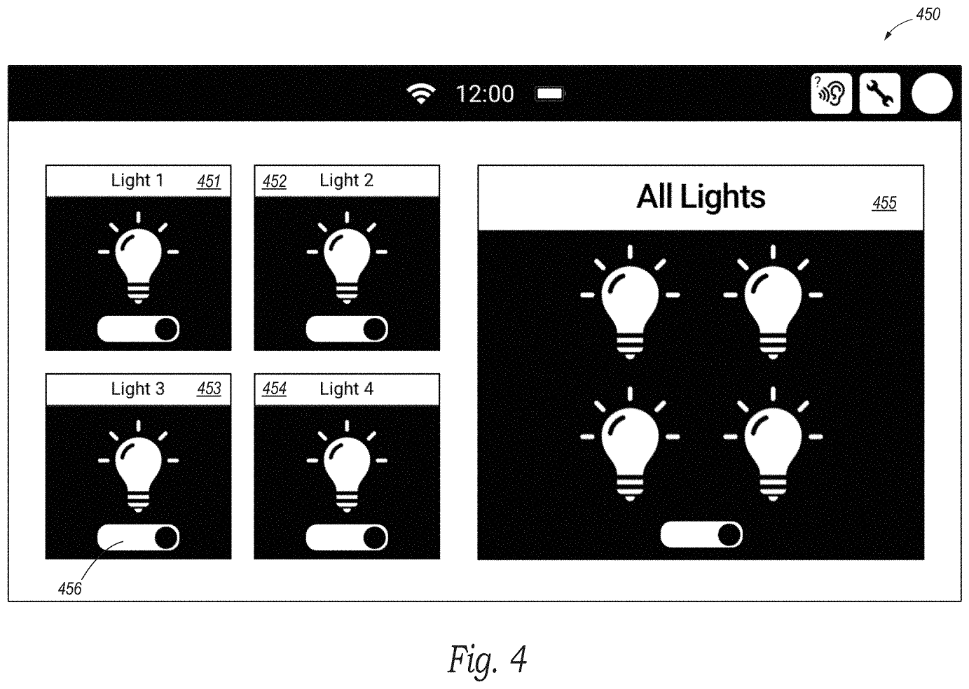

When a user selects the lighting tile 142 of the GUI 140, the screen 103 can navigate to a lighting control GUI to control power delivery to one or more lighting devices (e.g., lamps) connected to the system 100 via one or more of the lamp ports 114 (FIG. 1B) externally accessible via the system housing. For example, FIG. 4 illustrates a lighting control GUI 450 configured in accordance with implementations of the present technology. The lighting control GUI 450 includes several lighting symbols or icons 451-455. In the illustrated implementation, the lighting control GUI 450 includes a plurality of the lighting icon 451-454 that correspond to a respective plurality of lamp ports 114 (FIG. 1B) to selectively control the individual lamp ports 114 and the lamps 273 (FIG. 2) electrically connected thereto. The lighting control GUI 450 can also include a master lighting icon 455 that can control power delivery to all or a subset of the external lamp ports 114 (FIG. 1B). The lighting icons 451-455 can toggle and/or have a toggle bar 456 that can toggle between different states to indicate whether an external lighting device is connected to a lamp port 114 (FIG. 1B), and whether the connected external lighting device is powered on or off via the system 100. For example, in the implementation illustrated in FIG. 4, each of the lighting icons 451-455 are in a first state to indicate that an external lamp 273 is connected to a corresponding external lamp port 114 and is currently powered on (e.g., as shown by the first state of the light bulbs and/or by the color and/or position of the toggle bars 456). In other implementations, the lamp icons 451-455 can indicate the connection and/or the power states of corresponding external lamp ports 114 in other ways, such as by using different colors to indicate when an external lamp 273 is connected to a corresponding external lamp port 114 and/or when the connected external lamp is powered on. A user can toggle power supplied to an individual external lamp port 114 by selecting (e.g., touching, clicking on, etc.) the corresponding lamp icon 451-454 and/or toggle bar 456 on the lighting control GUI 450. Additionally or alternatively, the user (i) can simultaneously toggle power supplied to all or a subset of the external lamp ports 114 and/or (ii) can adjust each of the external lamp ports 114 currently connected to an external lamp to the same power state (i.e., on, off, or to a specified power level) by selecting the grouped lighting icon 455 and/or toggle bar 456. In this manner, the user can conveniently view and/or control which external lamps 273 connected to the system 100 are currently on and/or which are currently off via the lighting control GUI 450.

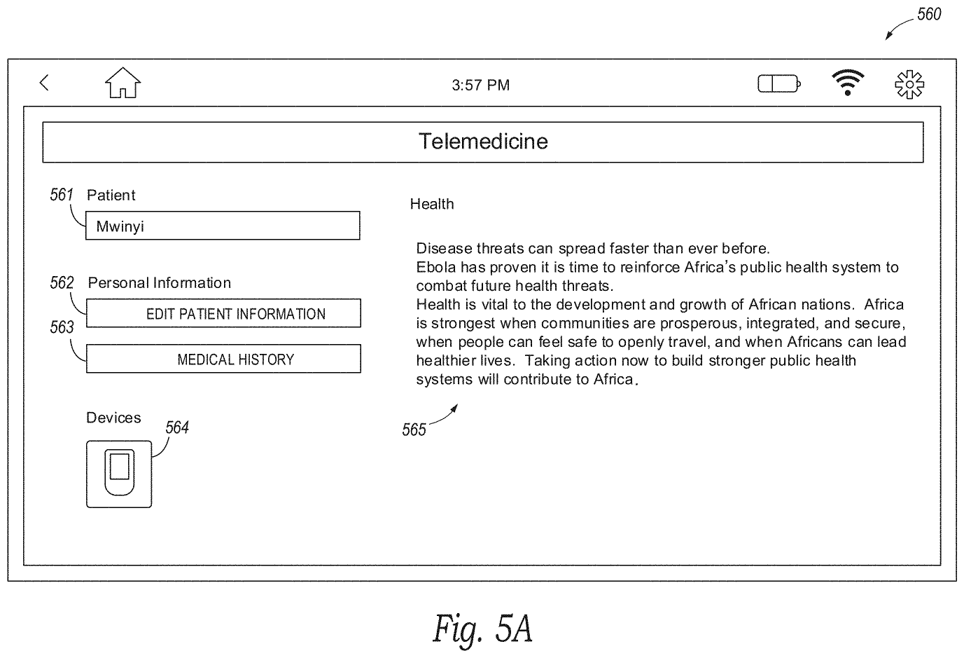

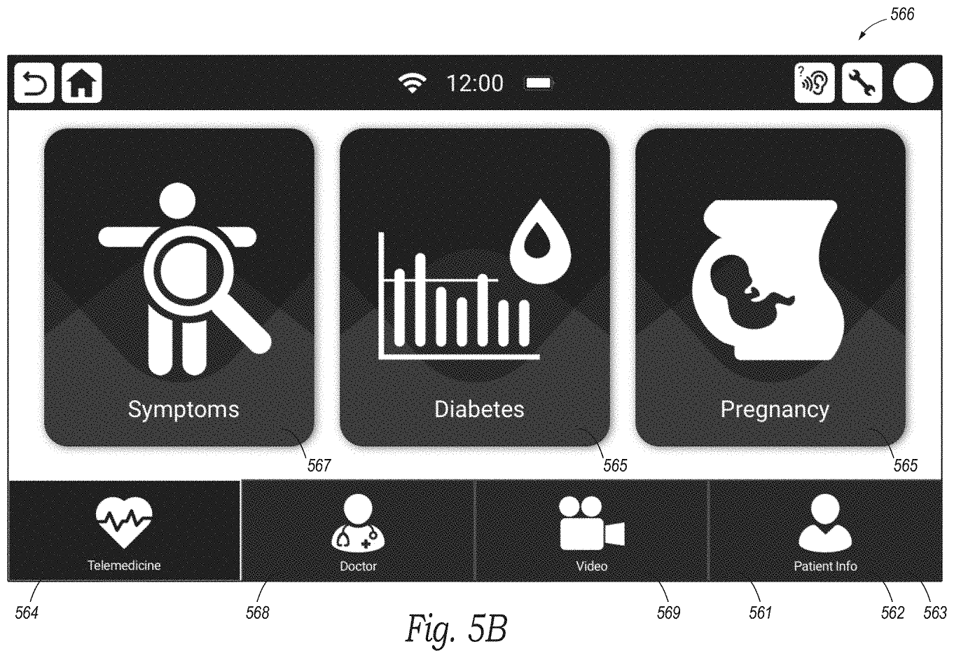

Referring back to FIG. 1A, when a user selects the health tile 146 of the main GUI 140, the screen 103 can navigate to a health GUI that includes several fields or buttons for providing healthcare information and/or communicating with healthcare professionals. For example, FIGS. 5A and 5B illustrate health GUI's 560 and 566 configured in accordance with implementations of the present technology. In the implementation illustrated in FIG. 5A, the health GUI 560 can include a patient and/or user field 561 where a user can select a patient of interest (e.g., the user himself/herself, family members, etc.). The health GUI 560 can include an edit patient information button 562 that, when selected, can cause the system 100 to display a separate GUI in which a user can edit and/or input information regarding the selected patient. The health GUI 560 can additionally or alternatively display a medical history button 563 that, when selected, can cause the system 100 to display a separate GUI that can present the selected patient's medical records to the user. In these and other implementations, the health GUI 560 can include a devices button 564 that, when selected, can cause the system 100 to display a separate GUI corresponding to one or more medical devices (e.g., a blood pressure monitor, a glucose monitor, a pulse oximeter, etc.) integrated with, connected to, and/or in communication with the system 100 (e.g., via one or more of the USB ports 110 or a Bluetooth connection). In some implementations, the system 100 can receive data collected and/or measured by a connected medical device, communicate the data to a medical professional (e.g., in real-time and/or by storing the data in a database accessible by the medical professional), and/or analyze the data (e.g., by performing one or more medical tests and/or for purposes of diagnosis). The health GUI 560 can additionally or alternatively include a medical information field 565 that can display pertinent and/or appropriate medical information for educational and/or diagnosis purposes.

In these and still other implementations, the health GUI 560 and/or 566 can include other fields and/or buttons. For example, the health GUI 566 illustrated in FIG. 5B includes a symptoms search button 567, a doctor information button 568, and a contact medical professional button 569. The symptoms search button 567 can search a database of symptoms to help identify possible diagnoses. The doctor information button 568 can access database of medical professionals to allow the user to search for doctors or other medical professionals based on specialty, service area, availability, and/or other physician-related characteristics. The contact medical professional button 569 can initiate a video and/or voice call (e.g., over a network, such as the internet) to a medical professional. In some implementations, and the health GUI 569 (FIG. 5A) and/or the health GUI 566 can include other fields and/or buttons, such as a patient portal button that can initiate a chat window with a medical professional and/or can allow a user to communicate with a medical professional in writing.

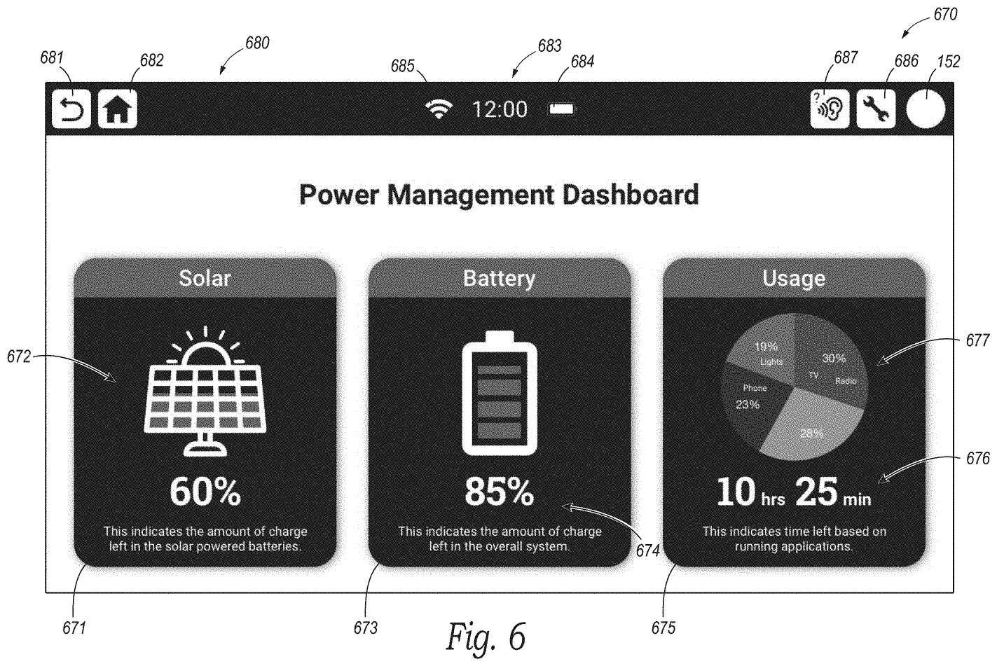

Referring again to FIG. 1A, when a user selects the power management button 149 of the main GUI 140, the screen 103 can navigate to a power management GUI that displays various power information of the system 100. For example, FIG. 6 illustrates a power management GUI 670 configured in accordance with implementations of the present technology. The system 100 can display the power management GUI 670 on the screen 103 (FIG. 1A) when a user selects the power management button 149 (FIG. 1A) on the GUI 140 (FIG. 1A). In the illustrated implementation, the power management GUI 670 displays a solar power usage field 671 that includes information regarding how much solar power the system 100 has captured and/or consumed. In some implementations, the solar power usage field 671 can include one or more tables and/or graphs 672 that can present how much solar power remains on and/or is collected by one or more solar panels connected to the system 100 and/or how much solar power is used at certain times of the day. In these and other implementations, the power management GUI 670 can include a battery information field 673. The battery information field 673 can provide a visual indication 674 of how much power remains on the first battery 160 (FIG. 1C) and/or on the second battery 170 (FIG. 1C). In these and still other implementations, the power management GUI 670 can include a device power usage field 675. The device power usage field 675 can provide a visual indication 676 of how long the system 100 is projected to supply power to currently running devices and/or applications before the first battery 160 and/or the second battery 170 are depleted. In some implementations, the device power usage field 675 can additionally or alternatively include one or more tables and/or graphs 677 that can display how much power each connected device, application, service, or function is consuming and/or has consumed. In this manner, the power management GUI 670 can notify the user of which devices, applications, services, and/or functions are most responsible for draining power from the first battery 160 and/or from the second battery 170. In these and still other implementations, the power management GUI 670 can include other power management fields and/or can display other power management information (e.g., a projected time to full charge) in addition to or in lieu of the fields and/or information illustrated in FIG. 6.

In further shown in FIG. 6, the power management GUI 670, as well as other GUI's of the system 100 can include a ribbon 680 that provides users quick access to specific system commands, information, and/or administrative GUI's. For example, the ribbon 680 can include a back icon 681 to toggle the screen to the previous GUI, a home icon 682 to return to a home (e.g., the main GUI 140) or default display configuration, a clock 683, a battery icon 684 (e.g., the power management button 149) to provide a visual indication of how much power remains in the first battery 160 and/or in the second battery 170, one or more connectivity icons 685, a settings icon 686 to display an administrative GUI that allows adjustment of overall system settings (e.g., language, time zone, screen brightness, etc.), a volume icon 687 to allow a user to adjust the volume of the system, and/or a miniaturized version of the user's profile identifier 152. The connectivity icons 685 can include visual indications of connectivity and/or signal strength to one or more communication mediums. For example, the connectivity icons 685 can include a WiFi icon to indicate (i) whether the system 100 is currently wirelessly connected to the internet and/or (ii) the signal strength of the received wireless signal; a Bluetooth icon to indicate whether the system 100 is connected to another device via Bluetooth and/or whether Bluetooth is enabled; a cellular icon to indicate (i) whether the system 100 is receiving a cellular signal (e.g., 3G, 4G, LTE, etc.) and/or (ii) the strength of a received signal; and/or an ethernet icon to display whether the system 100 is currently connected to the internet via a hard line, ethernet connection. In some implementations, one or more of the connectivity icons 685 can be altered (e.g., “greyed out”) to indicate that the corresponding communication medium is available, that networks and/or connections are available, and/or that the system 100 is not currently connected. In these and other implementations, a user can select (e.g., touch, click on, etc.) the greyed out connectivity icons 685, which can cause the system 100 to display a corresponding GUI where the user can select a network/device and/or can input necessary network/device credentials.

The system 100 can display numerous additional or other tiles that, when selected or activated, can navigate the screen 103 to corresponding GUIs to provide various functions and/or information to the user. For example, the system 100 can include a smart farming tile 150, a navigation tile, an internet tile, a camera tile, an electronic correspondence tile, a contacts tile, and/or other tiles that relate to the numerous features that are provided by the system 100. When each tile is selected, the screen 103 can navigate to one or more GUIs corresponding to the selected tile to enable the user to access the capability associated with that tile. For example, selection of the smart farming tile 150 can cause the screen to display a smart farming GUI to allow the user access to educational information related to farming, such as farming tutorials, guides, and/or other information related to crops, climate, and/or farming techniques. The smart farming GUI may also or alternatively allow entry of farming information related to his or her crops (e.g., via user manual input or smart farming devices communicatively coupled to the system 100), and thereby track their growth progress. In these and other implementations, the smart farming GUI can also provide recommendations to the user in view of the received farming information and/or other known parameters, such as weather forecasts. Selection of a navigation tile can cause the screen 103 to display a navigation GUI to allow the user to enter location and destination information. The navigation GUI can display map and/or navigation information (e.g., driving or walking directions) corresponding to the current location of the system 100 and/or to the entered location and/or destination information. Selection of the internet tile can navigate the screen 103 to a web browser. Selection of the camera tile can navigate the screen 103 to a camera GUI, which displays objects and/or people within a field of view of the camera 108, allows users to take photos using the camera 108, and/or allows users to apply one or more effects or edits to captured photos. Selection of an electronic correspondence tile (e.g., a text and/or email tile) can navigate the screen 103 to a text and/or email GUI that displays the user's received texts and/or emails, and/or allows the user to send texts and/or emails. Selection of the contacts tile can navigate the screen 103 to a contacts GUI that displays the stored or remotely accessed contact information for individuals, companies, service providers, and/or other entities associated with the user, the system 100, and/or the system location. The user may be able to edit or add contact information locally at the system 100 and/or contact information can be added, updated, and/or removed remotely.

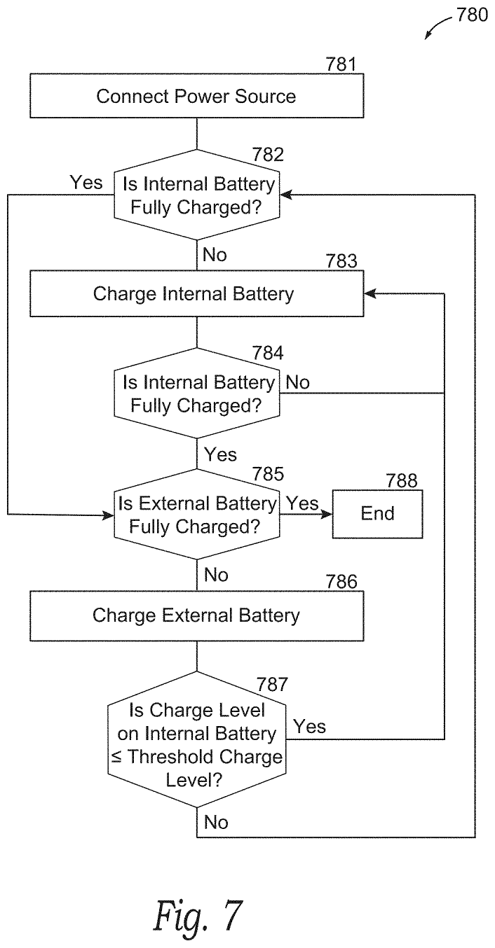

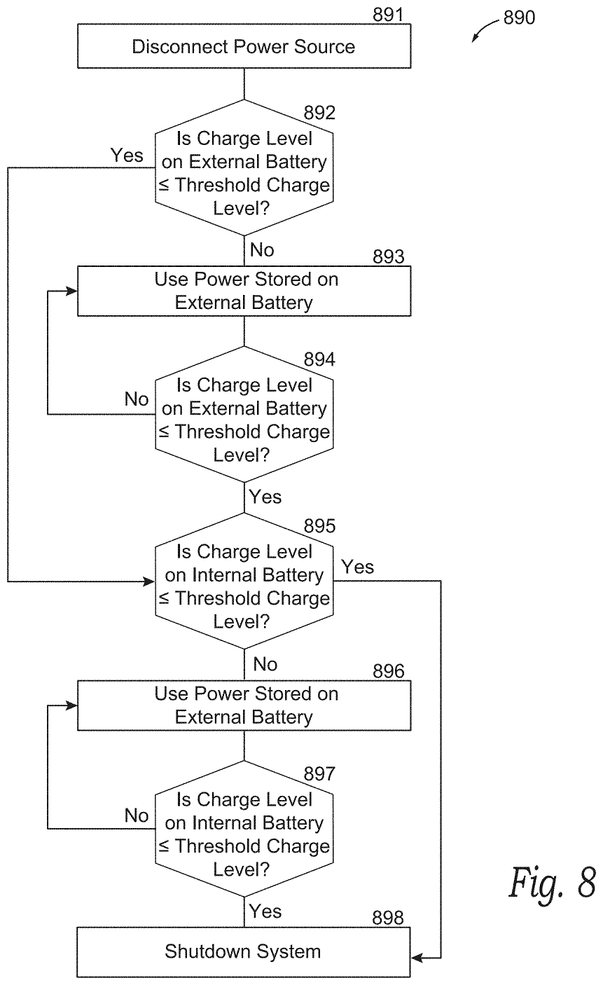

In use, the system 100 is an intelligent platform technology that provides both energy and connectivity to regions without a consistent power supply and/or communication network, and therefore brings the advantages of power and connectivity to remote, undeveloped, and/or disaster-stricken regions. The system 100 can harvest solar energy through the solar panel(s) 121 (e.g., a 120 W solar panel), store the harvested energy in the first and/or second batteries 160 and 170, and use the stored energy to generate electrical energy to operate the system 100 itself and provide the energy necessary to drive peripheral devices (e.g., connected via the USB ports 110). For example, the system 100 can be used to power several light fixtures 273 (e.g., four separate LED light fixtures), mobile phones, tablets, computers, medical devices, refrigerators, sewing machines, and/or other electronic devices. The light fixtures may be LED light systems or lamps that interface with the system 100 to run on low voltage direct current electricity that serve as brighter, safer, and significantly more environmentally friendly lighting alternatives to kerosene lamps typically used in off-grid or disaster regions. In some implementations, the system 100 charges one or more batteries (e.g., the first battery 160) to 336 Wh in about 4 hours, and can be configured to prolong the entire operation performance run time of the system 100 to a maximum of 22 hours. In other implementations, the system 100 can charge batteries to higher or lower levels of power and/or do so in less than or more than 4 hrs. In these and other implementations, the system 100 can include features, such as the power management routines discussed below with reference to FIGS. 7 and 8, to even longer overall system run times.

The system 100 also enables users to easily view, monitor, and/or control power, connectivity, lighting or other external devices operably connected to the system 100, and/or the consumption of information (e.g., news, weather, healthcare data, educational information, etc.) via the screen 103 and the GUIs displayed thereon. For example, the system 100 can provide TV and radio capabilities to bring local news, information, and entertainment to off-grid communities. The single circuit board 120 can also include numerous connectivity features (e.g., 2G, 3G, 4G, LTE, WiFi, Bluetooth, TVWS, and satellite) to provide numerous mechanisms for users to partake in one-way and/or two-way connectivity. Furthermore, the integrated sensors can detect and warn against hazards, such as carbon dioxide levels, temperatures, and humidity. In addition, the numerous applications and functions of the system 100 can be controlled via the application-specific GUIs displayed on the screen 103 to enhance user operability.

FIG. 7 is a flow diagram illustrating a power management method or routine 780 for charging one or more internal and/or external batteries in accordance with implementations of the present technology. In some implementations and as described below, the routine 780 can be executed, at least in part, by the modular system 100 described above with reference to FIGS. 1A-6 to control charging of the first battery 160 and/or the external batter 170. For example, the routine 780 can be executed by the micro controller 230; the microprocessor 240; the power management system 260; one or more memory modules (e.g., the EEPROM 241, the DDR3 DRAM 242, the NAND flash 243, and/or the NOR flash 384); the first battery 160; the second battery 170; and/or devices, circuits, and/or components of the power management system 260, such as the solar charge controller 261 and/or the switchers 263-265 illustrated in FIGS. 1A-3B. In other implementations, the routine 780 can be executed using one or more other power management systems.

At block 781, the routine 780 begins by connecting a power source to the system 100. For example, the routine 780 can be invoked when a DC power supply is connected to the system 100 via the DC power supply port 116. The power source can include one or more solar panels, the second battery 170, and/or another power generation or storage source. In some implementations, the routine 780 can automatically proceed to block 782 after power source connection. In other implementations, the routine 780 can wait to proceed to block 782 until one or more predetermined conditions are met. For example, the routine 780 can wait until the connected power source has sufficient power available to (i) charge the first battery 160 and/or the second battery 170, and/or (ii) supply power to all or a subset of the active devices, circuits, and/or components on and/or connected to the system 100 (e.g., lamps electrically coupled to the system 100).

At block 782, the routine 780 initially determines whether the first battery 160 is fully charged or charged to a predetermined threshold charge level. In some implementations, the routine 780 can determine whether the first battery 160 is fully charged by monitoring a voltage value presented at a shutdown SHDN pin of the solar charge controller 261 corresponding to the first battery 160, and comparing the detected voltage value to a predetermined threshold voltage value (e.g., 0.9V). If the voltage value presented at the shutdown SHDN pin corresponding to the first battery 160 is greater than or equal to a predetermined threshold voltage value (e.g., 0.9V), the routine 780 can determine that the first battery 160 is not fully charged. Upon determination that the first battery 160 is not fully charged, the routine 780 can proceed to block 783 to charge the first battery 160. In some implementations, the routine 780 can continue to charge the first battery 160 until the first battery 160 is fully charged or at least until the system 100 is disconnected from one or more power sources. If the voltage value presented at the shutdown SHDN pin corresponding to the first battery 160 is less than or equal to a threshold voltage (e.g., 0.9V or a lower value, such as 0.3V), the routine 780 can determine that the first battery 160 is fully charged, and the routine 780 can proceed to block 785 to determine whether the second battery 170 is fully charged.

As the first battery 160 charges (block 783), the routine 780 can continuously or intermittently determine whether the first battery 160 is fully charged or charged to the predetermined threshold charge level (block 784), and do so in a manner similar to that described in connection with block 782. If the routine 780 determines that the first battery 160 is not fully charged, the routine 780 returns to block 783 to continue charging the first battery 160.

Once the routine 780 determines that the internal battery is fully charged or charged to the desired degree, the routine 780 proceeds to block 785 to determine whether the second battery 170 is fully charged or charged to a predetermined threshold charge level. In some implementations, the routine 780 can determine whether the second battery 170 is fully charged by monitoring a voltage value presented at a shutdown SHDN pin of the solar charge controller 261 corresponding to the second battery 170. If the voltage value presented at the shutdown SHDN pin corresponding to the second battery 170 is greater than or equal to a threshold voltage value (e.g., 0.9V), the routine 780 can correlate this condition to identify that the second battery 170 is not fully charged. If the second battery 170 is not fully charged, the routine 780 proceeds to block 786 to charge the second battery 170. If the voltage value presented at the shutdown SHDN pin corresponding to the second battery 170 is less than or equal to a threshold voltage (e.g., 0.9V or a lower value, such as 0.3V), the routine 780 can affirm that the second battery 170 is fully charged.

In some implementations of the routine 780, the voltage values presented at the internal and external battery shutdown SHDN pins of the solar charge controller 261 are dependent on each other. For example, in certain implementations, when the voltage value presented at the internal battery SHDN pin is greater than or equal to the threshold value, the voltage value presented at the external battery shutdown SHDN pin c will be less than or equal to the threshold value. Similarly, if the voltage value presented at the external battery shutdown SHDN pin is greater than or equal to the threshold value, the voltage value presented at the internal battery shutdown SHDN pin will be less than or equal to the threshold value.

When the second battery 170 is not charged to a desired degree, the routine 780 can continue to charge the second battery 170 until the second battery 170 is fully charged and/or charged to the desired threshold charge level, or at least continue to the second battery 170 until the system 100 is disconnected from one or more power sources.

The power level of the first battery 160 may decrease during the charging of the second battery 170 because the first battery 160 may be used to run system functions and/or power externally connected devices (e.g., lamps). Accordingly, in some implementations, the routine 780 can continuously or periodically determine whether the charge level of the first battery 160 has fallen below a threshold level of charge while the second battery 170 is charging (block 787), and revert to charging the internal batter 160 (block 783) to ensure its charge level always remains above the predetermined threshold charge level while power is connected to the system 100. In some implementations, the routine 780 can determine whether the first battery 160 has dropped below a threshold level of charge in a manner similar to the routine 780 at blocks 782 and/or 784. In these and other implementations, the routine 780 can use a different threshold voltage value than used at blocks 782 and/or 784. For example, the routine 780 can use a threshold voltage value corresponding to a 10V or higher (e.g., 14V) charge level on the first battery 160 to preserve the life cycle of the first battery 160. If the routine 780 determines that the first battery 160 has dropped below the threshold level of charge, the routine 780 can return to block 783 to charge the first battery 160. However, if the routine 780 determines that the first battery 160 has not dropped below the threshold level of charge, the routine 780 can return to block 782 to determine whether the first battery 160 is fully charged. In some implementations, the routine 780 can delay returning to block 782 until the second battery 170 is fully charged and/or the internal battery drops below the threshold charge level.

Once both the internal and external batteries are fully charged or are charged to a desired threshold charge level, the routine can terminate (block 788). In these and other implementations, the routine 780 can proceed to block 788 when one or more power sources are disconnected from the system 100.

Although the steps of routine 780 are discussed and illustrated in a particular order, the routine 780 is not so limited. In other implementations, the routine 780 can perform steps in a different order. In these and other implementations, any of the steps of the routine 780 can be performed before, during, and/or after any of the other steps of the routine 780. Furthermore, a person of ordinary skill in the art will readily recognize that the routine 780 can be altered and still remain within these and other implementations of the present technology. For example, the routine 780 in some implementations can proceed to block 788 when the second battery 170 is fully charged (blocks 785 and 786) and the first battery 160 has not dropped below the threshold charge level (e.g., determined at block 787). Moreover, one or more steps of the routine 780 illustrated in FIG. 7 can be omitted and/or repeated in some implementations.

FIG. 8 is a flow diagram illustrating a power management method or routine 890 for managing battery power of a modular connectivity and energy system (e.g., the system 100) in accordance with implementations of the present technology. As described below, the routine 890 can be executed, at least in part, by the modular system 100 to manage battery power stored on the first battery 160, the second battery 170, and/or other power storage devices electrically coupled to the system 100. For example, the routine 890 can be executed by the micro controller 230; the microprocessor 240; the power management system 260; one or more memory modules (e.g., the EEPROM 241 the DDR3 DRAM 242, the NAND flash 243, and/or the NOR flash 384); the first battery 160; the second battery 170; and/or devices, circuits, and/or components of the power management system 260, such as the solar charge controller 261 and/or the switchers 263-265 illustrated in FIGS. 1A 3B. In other implementations, the routine 890 can be executed using one or more other power management systems.

At block 891, the routine 890 can begin when one or more power sources are disconnected from the system 100. For example, the routine 890 can be invoked when a DC power supply is disconnected from the system 100. For example, the routine 890 can begin when the second battery 170 and/or a solar panel is disconnected from the system 100. In other implementations, the routine 890 may be invoked while a power source is still connected to and/or charging components of the system 100, at the same time as components of the system 100 or external devices electrically coupled thereto are receiving power from the system.

Once invoked, the routine 890 can proceed to block 892 to determine whether the charge level on the second battery 170 is less than or equal to a threshold charge level. In some implementations, the threshold charge level can be a predetermined voltage value (e.g., 10V) that the second battery 170 is inhibited (e.g., prevented) from dropping below to maintain or reduce adverse effects to the life cycle of the second battery 170. The routine 890 can determine whether the charge level on the second battery 170 is less than or equal to the threshold charge level by monitoring a voltage value presented at a shutdown SHDN pin of the solar charge controller 261 corresponding to the second battery 170. If the voltage value presented at the shutdown SHDN pin corresponding to the second battery 170 is greater than or equal to a threshold voltage value (e.g., 0.9V) corresponding to the threshold charge level, the routine 890 can determine that the charge level on the second battery 170 is less than or equal to the threshold charge level. When the charge level on the second battery 170 is less than or equal to the threshold charge level, the routine 890 can proceed to block 895 to determine whether the charge level on the first battery 160 is less than or equal to a threshold charge level.

If the voltage value presented at the shutdown SHDN pin corresponding to the second battery 170 is less than or equal to a threshold voltage value (e.g., 0.9V or a lower value, such as 0.3V), the routine 890 can determine that the charge level on the second battery 170 is greater than or equal to the threshold charge level. Upon making this determination, the routine 890 can proceed to block 893 to use power stored on the second battery 170 to operate the functions of the system 100 and/or supply energy to external devices (e.g., lamps). In these and other implementations, the routine 890 can be configured to periodically proceed to block 894 to determine whether the charge level on the second battery 170 is less than or equal to a threshold charge level.

If the routine 890 determines that the second battery 170 is not connected to the system 100, the routine 890 can bypass blocks 891 and 892, and proceed to block 894. At block 894, the routine 890 can determine whether the charge level on the second battery 170 is less than or equal to a threshold charge level, which can be the same or different threshold charge level as the threshold charge level at block 892. For example, this charge level determination can be made in a manner similar to the routine 890 at block 892. If the routine 890 determines that the charge level on the second battery 170 is greater than or equal to the threshold charge level, the routine 890 can return to block 893 to use power stored on the second battery 170.

When the routine 890 determines that the charge level of the second battery 170 is less than or equal to the threshold charge level, the routine 890 can proceed to block 895 to determine whether the charge level on the first battery 160 is less than or equal to a threshold charge level. The threshold charge level can be equal to or higher than a voltage value (e.g., 10V) that the first battery 160 is inhibited (e.g., prevented) from dropping below to maintain the life cycle of the first battery 160. In some implementations, the threshold charge value can be the same threshold charge level as the threshold charge value used for the second battery 170 at blocks 892 and 894 (e.g., when the first battery 160 is identical to the second battery 170). In other implementations, the threshold charge value can be a different threshold charge level than the threshold charge value used for the second battery 170 at blocks 892 and 894.

In these and other implementations, the routine 890 can determine whether the charge level on the first battery 160 is less than or equal to the threshold charge level by monitoring a voltage value presented at the internal battery shutdown SHDN pin of the solar charge controller 261. If the voltage value presented at the shutdown SHDN pin corresponding to the first battery 160 is greater than or equal to a threshold voltage value (e.g., 0.9V) corresponding to the threshold charge level, the routine 890 can determine that the charge level on the first battery 160 is less than or equal to the threshold charge level, and the routine 890 can proceed to block 898 to shut down the system 100. When the voltage value presented at the shutdown SHDN pin corresponding to the first battery 160 is less than or equal to a threshold voltage value (e.g., 0.9V or a lower value, such as 0.3V), the routine 890 can determine that the charge level on the first battery 160 is greater than or equal to the threshold charge level.

When the routine 890 determines that the internal battery threshold charge level is met, the routine 890 proceeds to block 896 to use power stored on the first battery 160. For example, the routine 890 can use power stored on the first battery 160 by supplying power to one or more devices connected to the system 100, such as one or more active devices, circuits, and/or components on and/or connected to the system 100.

In these and other implementations, the routine 890 can be configured to periodically proceed to block 897 to determine whether the charge level on the first battery 160 is less than or equal to a threshold charge level. In some implementations, the routine 890 can determine whether the charge level on the first battery 160 is less than or equal to the threshold charge level in a manner similar to the routine 890 at block 895. The threshold charge level at block 897 can be the same as or different from the threshold charge level at block 895. If the routine 890 determines that the charge level on the first battery 160 is greater than or equal to the threshold charge level, the routine 890 can return to block 896 to use power stored on the first battery 160.

When the routine 890 determines that the charge level of the first battery 160 is less than or equal to the threshold charge level, the routine 890 can proceed to block 898 to shut down the system 100. In some implementations, the routine 890 can shut down the system 100 when the charge levels on the first battery 160 and on the second battery 170 are less than or equal to respective threshold charge levels. In these and other implementations, the routine 890 can shut down the system 100 when the charge level on only the first battery 160 is less than or equal to a respective threshold charge level (e.g., when the second battery 170 is not connected to the system 100).

Although the steps of routine 890 are discussed and illustrated in a particular order, the routine 890 is not so limited. In other implementations, the routine 890 can perform steps in a different order. In these and other implementations, any of the steps of the routine 890 can be performed before, during, and/or after any of the other steps of the routine 890. Furthermore, a person of ordinary skill in the art will readily recognize that the routine 890 can be altered and still remain within these and other implementations of the present technology. For example, when one or more power sources are reconnected to the system 100, the routine 890 can terminate before, during, and/or after executing any of the blocks 891-898 of the routine 890. Moreover, one or more steps of the routine 890 illustrated in FIG. 8 can be omitted and/or repeated in some implementations.

Although not shown so as to avoid unnecessarily obscuring the description of the implementations of the technology, any of the forgoing systems and methods described above in FIGS. 1A-8 can include and/or be performed by a computing device configured to direct and/or arrange components of the systems and/or to receive, arrange, store, analyze, and/or otherwise process data received, for example, from the machine and/or other components of the systems. As such, such a computing device includes the necessary hardware and corresponding computer-executable instructions to perform these tasks. More specifically, a computing device configured in accordance with an implementation of the present technology can include a processor, a storage device, input/output devices, one or more sensors, and/or any other suitable subsystems and/or components (e.g., displays, speakers, communication modules, etc.). The storage device can include a set of circuits or a network of storage components configured to retain information and provide access to the retained information. For example, the storage device can include volatile and/or non-volatile memory. As a more specific example, the storage device can include random access memory (RAM), magnetic disks or tapes, and/or flash memory.

The computing device can also include computer readable media (e.g., the storage device, disk drives, and/or other storage media, excluding only a transitory, propagating signal per se) including computer-executable instructions stored thereon that, when executed by the processor and/or computing device, cause the systems to perform adaptive illumination and/or visualization improvement as described in detail above with reference to FIGS. 1A-8. Moreover, the processor can be configured for performing or otherwise controlling steps, calculations, analysis, and any other functions associated with the methods described herein.

In some implementations, the storage device can store one or more databases used to store data collected by the systems as well as data used to direct and/or adjust components of the systems. In one implementation, for example, a database is an HTML file designed by the assignee of the present disclosure. In other implementations, however, data is stored in other types of databases or data files.

One of ordinary skill in the art will understand that various components of the systems (e.g., the computing device) can be further divided into subcomponents, or that various components and functions of the systems may be combined and integrated. In addition, these components can communicate via wired and/or wireless communication, as well as by information contained in the storage media.

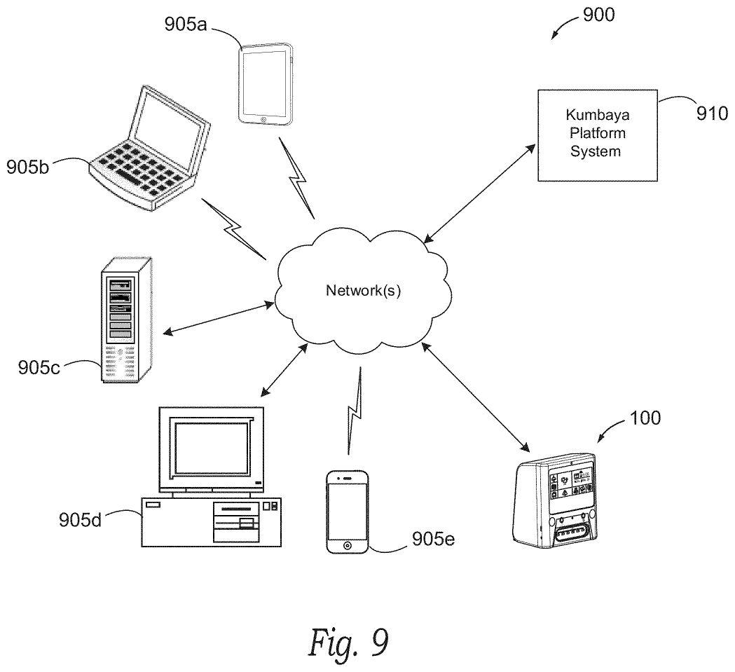

FIG. 9 is a block diagram of an environment 900 in which a modular connectivity and power management system 100 operates, configured in accordance with implementations of the present technology. In the environment 900, the system 100 can connect to (e.g., wirelessly and/or via one or more wires) and/or communicate with one or more devices 905 (identified individually as 905a-e in FIG. 9) over one or more networks 930, including public or private networks (e.g., the internet). The one or more devices 905 can include personal computers, server computers, handheld or laptop devices, cellular telephones, wearable electronics, tablet devices, multiprocessor systems, microprocessor-based systems, set-top boxes, programmable consumer electronics, network PCs, minicomputers, mainframe computers, distributed computing environments that include any of the above systems or devices, or the like. In these and other implementations, the one or more devices 905 can include other remote or local devices, such as landline phones, fax machines, medical devices, thermostats, speakers, and other devices.

As shown in FIG. 9, the system 100 can connect to and/or communicate with one or more remote servers/databases 910. In some implementations, a remote server/database 910 can be an edge server which receives client requests and coordinates fulfillment of those requests through other servers. The remote server/database 910 can comprise computing systems, such as a system 100. Although the remote sever/database 910 is displayed logically as a single server/database, the remote server/database 910 can be a distributed computing environment encompassing multiple computing devices and/or databases located at the same or at geographically disparate physical locations. In some implementations, the remote server/database 910 corresponds to a group of servers.

In some implementations, the one or more devices 905, the system 100, and/or the remote server/database 910 can each act as a server or client to other server/client devices. The remote server/database 910 can include one or more databases. As discussed above, the one or more databases can warehouse (e.g. store) information such as educational lessons, farming information, health information, various alerts or warnings, user profiles, temperature/weather information, contact information, drivers/software necessary to operate certain applications and/or devices, and/or other information.

The one or more networks 930 allow for communication in the environment 900. The one or more networks 930 can include one or more wireless networks, such as, but not limited to, one or more of a Local Area Network (LAN), Wireless Local Area Network (WLAN), a Personal Area Network (PAN), Campus Area Network (CAN), a Metropolitan Area Network (MAN), a Wide Area Network (WAN), a Wireless Wide Area Network (WWAN), Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 3.75G, 4G, 5G, LTE networks, enhanced data rates for GSM evolution (EDGE), General packet radio service (GPRS), enhanced GPRS, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols. Network 130 may also include wired networks.

### B. CONCLUSION

The above detailed descriptions of implementations of the technology are not intended to be exhaustive or to limit the technology to the precise form disclosed above. Although specific implementations of, and examples for, the technology are described above for illustrative purposes, various equivalent modifications are possible within the scope of the technology as those skilled in the relevant art will recognize. For example, although steps are presented in a given order above, alternative implementations may perform steps in a different order. Furthermore, the various implementations described herein may also be combined to provide further implementations.

From the foregoing, it will be appreciated that specific implementations of the technology have been described herein for purposes of illustration, but well-known structures and functions have not been shown or described in detail to avoid unnecessarily obscuring the description of the implementations of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular implementations may also be combined or eliminated in other implementations. Furthermore, although advantages associated with certain implementations of the technology have been described in the context of those implementations, other implementations may also exhibit such advantages, and not all implementations need necessarily exhibit such advantages to fall within the scope of the technology. Accordingly, the disclosure and associated technology can encompass other implementations not expressly shown or described herein.

I/We claim:

1. A modular system, comprising:
a housing;
a display; and
a single, active printed circuit board within the housing,
wherein the printed circuit board includes a microprocessor, a micro controller, a power management system, a plurality of communication devices, and at least one universal serial bus (USB) port, and
wherein the modular system is configured to directly connect to and be powered by a solar panel.

2. The modular system of claim 1, further comprising an internal battery and/or an external battery, wherein the internal battery and/or the external battery are electrically coupled to the printed circuit board.

3. The modular system of claim 1, further comprising an internal battery and an external battery, wherein the external battery is identical to the internal battery.

4. The modular system of claim 1, wherein the plurality of communication devices includes at least two devices from a group of communication devices comprising a WiFi device, a cellular device, and a Bluetooth device.

5. The modular system of claim 1, wherein the power management system is a buck-boost switching regulatory battery charger that is configured to implement constant-current constant-voltage (CCCV) charging for an internal battery and/or for an external battery of the modular system.

6. The modular system of claim 1, wherein the power management system includes a solar charge controller configured to implement automatic maximum power point tracking (MPPT) for solar powered applications of the modular system.

7. The modular system of claim 1, wherein the modular system is further configured to connect to a DC power supply and/or to supply power to one or more external lamps.

8. The modular system of claim 1, wherein the printed circuit board further includes a radio and/or a television module.

9. The modular system of claim 1, further comprising (i) a camera within the housing and electrically coupled to the printed circuit board and/or (ii) a standard digital (SD) card reader.

10. The modular system of claim 1, wherein the modular system is configured to present one or more graphical user interfaces on the display, and wherein the one or more graphical user interfaces correspond to one or more applications and/or functions of the modular system.

11. A printed circuit board (PCB) for use in a modular system configured to directly connect to a solar panel, the PCB comprising:
a microprocessor;
a power management system;
a plurality of communication devices; and
a plurality of USB ports,
wherein the power management system, the plurality of communication devices, and the plurality of USB ports are configured to directly interface with the microprocessor.

12. The PCB of claim 11, wherein the power management system includes a plurality of components, wherein the plurality of components includes a solar charge controller and one or more switcher circuits, and wherein components of the plurality of components are positioned proximal one another on the PCB.

13. The PCB of claim 11, wherein the plurality of communication devices includes at least two devices from a group of communication devices comprising a WiFi device, a cellular device, and a Bluetooth device, and wherein the at least two devices of the plurality of communication devices are positioned proximal one another on the PCB.

14. The PCB of claim 11, wherein devices of the plurality of communication devices are positioned on the PCB at least 2 centimeters away from components of the power management system.

15. The PCB of claim 11, wherein the plurality of communication devices includes a mobile communication device and a mobile communication antenna, and wherein the mobile communication antenna is positioned away from copper and other conductive materials on the PCB.

16. The PCB of claim 11, further comprising a radio and/or a television module, wherein the radio and/or television module are positioned on the PCB at least 2 centimeters away from components of the power management system, and wherein the radio and/or television modular are further positioned on the PCB proximal to the plurality of communication devices.

17. The PCB of claim 11, further comprising a plurality of grounded lines, wherein grounded lines of the plurality of grounded lines are configured to minimize and/or eliminate crosstalk across data transmission lines and/or components of the PCB.

18. The PCB of claim 11, further comprising one or more memory modules, wherein the one or more memory modules are positioned on the PCB proximal to the microprocessor.

19. The PCB of claim 11, further comprising one or more memory modules, and wherein the one or more memory modules include an EEPROM memory module, a NAND flash memory module, a NOR flash memory module, and/or a DRAM memory module.

20. A method for charging an internal battery and an external battery of a modular system, the method comprising:
when the modular system is connected to a DC power source and/or a solar panel, determining whether the internal battery is fully charged; and
after determining that the internal battery is fully charge, determining whether the external battery is fully charged.

21. The method of claim 20, further comprising charging the internal battery until the internal battery is fully charged and/or until the modular system is disconnected from the DC power source and/or the solar panel.

22. The method of claim 20, wherein determining whether the internal battery and/or the external battery are fully charged includes monitoring a voltage value presented at a shutdown pin of a solar charge controller of a power management system of the modular system.

23. The method of claim 20, further comprising switching from charging the external battery to charging the internal battery when the internal battery drops below a threshold charge level.

24. A method for managing power stored on an internal battery and an external battery of a modular system, the method comprising:
comparing an amount of charge stored on the external battery to a first threshold amount of charge; and
when the amount of charge stored on the external battery is less than the first threshold amount of charge, comparing an amount of charge stored on the internal battery to a second threshold amount of charge.

25. The method of claim 24, wherein the first threshold amount of charge is he same as the second threshold amount of charge.

26. The method of claim 24, further comprising supplying power stored on the external battery to active devices, circuits, and/or components of the modular system when the amount of charge stored on the external battery is greater than the first threshold amount of charge.

27. The method of claim 24, wherein comparing the amount of charge on the external battery to the first threshold amount of charge and/or comparing the amount of charge on the internal battery to the second threshold amount of charge includes monitoring a voltage value presented at a shutdown pin of a solar charge controller of a power management system of the modular system.

28. The method of claim 24, further comprising supplying power stored on the internal battery to active devices, circuits, and/or components of the modular system when the amount of charge stored on the internal battery is greater than the second threshold amount of charge.

29. The method of claim 24, further comprising powering down the modular system when the amounts of charge stored on the external and on the internal batteries are less than the first and the second threshold amounts of charge, respectively.

30. The method of claim 24, wherein the first threshold amount of charge and/or the second threshold amount of charge is 10V or 14V.
